(19) United States
(12) Patent Application Publication
(10) Pub. No.: US 2002/0188624 A1
(43) Pub. Date: Dec. 12, 2002

(54) Active control protocol for peer-to-peer database replication

(76) Inventor: William Landin, Cleveland, OH (US)

Correspondence Address: William Landin, 4854 GLEETEN ROAD, CLEVELAND, OH, 44143, US

(21) Appl. No.: 10/120,818

(22) Filed: Apr. 12, 2002

Related U.S. Application Data
(60) Provisional application No. 60/283,177, filed on Apr. 12, 2001.

(51) Int. Cl. G06F 17/30; G06F 12/00

(52) U.S. Cl. 707/203

(57) ABSTRACT

A protocol is defined to provide a method of controlling, storing, distributing, and recovering replicas among a group of databases sharing common data within a processing network. This method does not broadcast any pending update information to its “peer” databases and each “peer” database does not store or use any information about any other transaction that may be occurring on other databases. Tables within a commonly accessible and logically separate control database (or multiple databases) hold both replica control information and any replica for each table that will be propagated. In the preferred embodiment, replication daemons (or agents) handle the propagation and the application of the replica to all other “peer” databases. Update receipt information may be added to those “peer” databases that have been designated for recovery processing. When necessary, the update receipt information is used to restore the control information in the control database.

### BACKGROUND OF THE INVENTION

Having common data at each processing node within a distributed computing network has been proven beneficial and is desirable for computer data processing. Most commercial database systems now provide several methods for capturing and propagating changed data to other similar databases with the network. These methods, however, impose very strict constraints on where the updates can be created and how they are captured and propagated, thereby limiting the usefulness and timeliness of the propagated data.

### DESCRIPTION OF THE PRIOR ART

Access by a computer program to data with a database is controlled by the concurrency control system of the local database management system (LDBMS). One aspect of that concurrency control system insures that multiple programs can access and update the same data records without overwriting each other's updates. In addition to the concurrency control of the LDBMS, when a program obtains and updates data records simultaneously in multiple databases, a Two-Phase Commit Protocol (2PC) insures that all updates are committed on each database or all are rolled back to maintain integrity.

When two or more databases contain similar information, it is desirable to be able to update the information on only one database and then propagate that change to all other desired databases in a timely manner when the records in those databases are available. All major commercial database systems now provide one or more data replication and propagation methods based on a “Primary-Secondary” methodology. Within this methodology, all record updates must first be applied to a designated “Primary” database (or tables). The update can be immediately captured by the LDBMS into a separate log file or, at a later time, captured via a snapshot process into an external file. These “replica” records in the log or external file are then periodically applied to all “Secondary” databases (or tables).

The use of a single “Primary” database for updates limits the amount of processing that can be done within a system. A read-only attribute may be imposed on all secondary databases and the time delay imposed by gathering and propagating replicas, severely limits their usefulness for users on the secondary databases. When “Primary” tables are used among several databases then the availability of the system is also limited by network congestion and is vulnerable to many network failures.

To overcome these and other limitations, an “update anywhere” methodology has been studied and discussed for many years. A major constraint in the methodology is controlling the updates so that none of them overwrite each other (called a “data collision”) and that they conform to “one-copy” serializability. Many established theories for controlling data propagation, update control methods, and their limitations are described by Bernstein, Buretta, and Ramaritham.

A number of U.S. Patients have been granted to others for their unique methods of capturing, controlling, and propagating replica information within an “update anywhere” methodology. Several recent patients include: Breibart et al. [U.S. Pat. No. 5,999,931] employs a method of broadcasting a replica to all available peer databases and allowing each database to independently apply or reject the replica depending if the update transaction is acyclic or not acyclic as determined by that peer database. Crowe et al, [U.S. Pat. No. 5,970,488] employs a method of broadcasting a replica to a specified “owning” process that is attached to each peer database and is independently applied or rejected depending if an update flag has been previously raised by another transaction. Sutter [U.S. Pat. #5,924,094] employs a method of periodically broadcasting the replica to each peer database and allowing the peer databases to apply or reject the replica based on the replica's timestamp.

### SUMMARY OF THBE INVENTION

A protocol is defined to provide a method of controlling, storing, distributing, and recovering replicas among a group of databases sharing common data within a processing network. This method does not broadcast any pending update information to its “peer” databases to obtain permission to apply the update and each “peer” database does not store any information about any other transaction that may be occurring on other databases. The “peer” databases in the processing group do not need to be identical.

One function of this protocol utilizes predefined program code to send control and update information to a logically separate central database (or databases) herein after referred to as the “ACP3” database. A validation function is performed by the source process at the ACP3 database the purpose of which is to guarantee the correct serial update of the data with respect to the other databases in the group. If the control information fails to pass that validation then an error is return to the source process disallowing the intended update. If the control information passes validation then an update receipt may be returned to the database of the source process and it's processing continues. The source process does not have to be attached to any other member of the processing database group to send control and update information to the ACP3 database. The source process may then continue to apply the update to the other databases in the group as a single synchronous update or/and it may leave the update information stored on the ACP3 database for other daemon (or agent) processes to propagate as individual asynchronous updates. The replica information can include information for both direct and indirect changes to existing data records, inserting new records, deleting old records, applying database schema changes, distributing new and changed program code, and many other full database functions. The update information is stored in the ACP3 database until all target databases have been successfully updated or the information is no longer required.

The protocol also provides for an optional central housekeeping daemon (agent) process. This process periodically checks the number of pending update information records in the central database, the number of propagating daemons, accessibility to each database in the processing group, and deletes those update information records in the ACP3 database that have been successfully propagated along with their update receipts at each of the processing group databases. The housekeeping daemon can start, stop, slow down, or speed up processing activity of the propagating daemons when the number of pending updates exceeds or falls below predefined limits. The housekeeping daemon can also flag processing group databases as temporarily inaccessible so that the propagating daemons don't wait idly for those connections. As a result, simple data replication can usually be fully completed in a matter of a few seconds after completion of the initial update.

This system is not vulnerable to a catastrophic single point of failure because programming is provided that will quickly rebuild the ACP3 database from the update receipts that are left with each update made at each of the processing group databases that have been designated as part of the recovery system. If a network partition occurs that prevents one or more of the processing group databases from accessing the ACP3 database, two recovery options are provided: a stand alone mode and a temporary recovery mode. Because assess is not possible to the ACP3 database, both of these options will allow updates that could create data collisions when those updates are later merged with the central database.

### DETAILED DESCRIPTION OF THE INVENTION

In typical single database processing, when an application program completes updating to one or more database records to its satisfaction, it submits the updates to the database for “commit” processing. At that time, the LDBMS checks the updates to insure they conform to all defined database constraints (such as any referential integrity constraints and delete validation) and executes any “trigger” programs or code that may be defined on any of the tables. If no errors or violations are detected, the updates are written to the database files and the application program continues normal processing. If an error or violation is identified, then an error code is returned to the application program and all updates are undone.

Within the scope of this invention, when a record has been submitted to the LDBMS for “commit” processing, a “trigger” program for that record will create an update control record with a sequence number in its controlling ACP3 database (a sample definition of the control record identified as ACP3.A3_RC is provided in the program listing section). The trigger program will then search the ACP3 database for the last control record for that intended replica to see if the intended replica is a target of a previous update from another database. If one is found, the trigger program removes its control record and returns an error to the application program. If no previous “non-incremental” update control record is found, the trigger program may then create an appropriate replica record of the update within the controlling database and may create an update receipt record within its originating database. The receipt record contains the same information as in the control record on the ACP3 database but is not maintained and is created on each “peer” database that has been designated for the recovery process. In the preferred embodiment, the trigger program will then terminate satisfactorily and return control to the LDBMS. Propagation of the replica to all other peer databases will then be left for other replication daemons to propagate as asynchronous updates. Or, as an alternative embodiment, the trigger program can continue to propagate the update to all other available peer database as a synchronous update provided that the update can be completed in proper sequential order. Propagation to all then unavailable “peer” databases would be handled as asynchronous updates by the replication daemons when those databases become available. All updates by the trigger code or replication daemons will be applied to each “peer” database in the same sequential order as when the updates were first generated.

The “trigger” program can be program code contained within the database management system itself or any program code that connects to the controlling database. It can also be executed as a “Find” trigger when a record is first found for update to test the record's updateable or to prevent the record from being updated on another peer database until this update has been finalized.

A “non-incremental” update is one that contains at least one changed field that is non-scalar. For example, an update would be considered “non-incremental” if the “customer name” field of a customer record is change from “Mary Doe” to “Mary Doe-Smith.” An update could be considered as “incremental” if the only changes made were on non-indexed scalar fields such as “customer current balance” and an optional control setting in this invention was set to allow this update type.

As each replica is applied to each peer database, the original control record in the ACP3 database is also updated to indicate that the peer database is no longer a target for that replication and a receipt record may be created in the peer database to document that update under control of 2PC. After a replica has been successfully applied to all of the peer databases and all databases that may be used for recovery are available for update, the housekeeping daemon will remove the original control record, any replica record, and any receipt records from each peer database and the ACP3 database as a single transaction for each completed replication within control of 2PC.

The housekeeping daemon may also maintain the connectivity status of each peer database within the controlling database. The trigger programs and the replication daemons can use these records to quickly determine if a target peer database is available so that they don't have to wait for an attempted connection to “time-out” on an unavailable peer database. The housekeeping daemon may also keep track of the number of active pending update records in the controlling database and use that information to control the number of active replication daemons.

In the preferred embodiment, the replication daemons will always propagate replicas in sequence number order for each record and will function in on one of two modes. Those daemons that execute on the same system as the control database (and any trigger code executed by any peer database that attempts to propagate a replica) will attempt to propagate (“push”) one replica at a time to all available peer databases. Those daemons that execute on the same system as their peer database will attempt to propagate (“pull”) only those replicas that are targeted for its database.

In the preferred embodiment, the ACP3 database will be physically separate, as well as logically separate, from any peer database and can be used to control any number of tables. It should not contain any “end-user” records or be directly accessible by any “end-user” process or application. The ACP3 database will contain the replication control table and may contain a database connection table. Sample definitions for each are shown in the program listing section. It may also hold any number of tables necessary to hold the replica, and any other tables necessary to help control the proper functioning of this invention. The ACP3 database must be able to generate sequence numbers or provide a unique incremental value for a specified field within the control record when it is created.

### REFERENCES CITED

Bernstein, Philip A. and Newcomer, Eric, Principles of Transaction Processing, Morgan Kaufmann Publishers, ISBN 1-55860-415-4, 1997.

Buretta, Marie, Data Replication—Tools and Techniques for Managing Distributed Information, John Wiley & Sons, Inc., ISBN 0-471-15754-6, 1997.

Ramamrithan, Krithi, and Chrysanthis, Panos K, Executive Briefing—Advances in Concurrency Control and Transaction Processing, IEEE Computer Society Press, ISBN 0-8186-7405-9, 1997.

U.S. Patent Documents

| | | | |
|---|---|---|---|
| 5924094 | Jul., 1999 | Sutter, Herbert P. | 707/10. |
| 5970488 | Oct., 1999 | Crowe et al. | 707/8. |
| 5999931 | Oct., 1997 | Breitart et al. | 707/10. |

CREATE TABLE ACP3.A3 RC
(A3RC SERIAL INTEGER

GENERATED ALWAYS AS IDENTITY
(START WITH 1, INCREMENT BY 1, NO CACHE ),

A3RC CTRL INTEGER NOT NULL WITH DEFAULT 0,

| | | |
|---|---|---|
| A3RC COMP DB | VARCHAR(50) | NOT NULL, |
| A3RC TRGT DB | VARCHAR(50) | NOT NULL, |
| A3RC UPD TYP | CHARACTER (2) | NOT NULL, |
| A3RC MPRG | VARCHAR(20), | |

| | | |
|---|---|---|
| A3RC TBL | VARCHAR (20) | NOT NULL, |

| | | |
|---|---|---|
| A3RC TBL Kl | VARCHAR(40) | NOT NULL, |
| A3RC TBL K2 | VARCHAR(40), | |
| A3RC TBL K3 | VARCHAR(40), | |
| A3RC TBL K4 | VARCHAR(40), | |

| | |
|---|---|
| A3RC UID | VARCHAR (20), |
| A3RC TS | TIMESTAMP, |

PRIMARY KEY(A3RC SERIAL)
) IN USERSPACE1

| | |
|---|---|
| COMMENT ON Table ACP3.A3 RC | IS ‘Replication Control Table’ |
| COMMENT ON COLUMN ACP3.A3 RC.A3RC SERIAL | IS ‘Auto-gen transaction serial number’ |
| COMMENT ON COLUMN ACP3.A3 RC.A3RC CTRL | IS ‘Replication control’ |
| COMMENT ON COLUMN ACP3.A3 RC.A3RC COMP DB | IS ‘Completed databases’ |
| COMMENT ON COLUMN ACP3.A3 RC.A3RC TRGT DB | IS ‘Target databases’ |
| COMMENT ON COLUMN ACP3.A3 RC.A3RC UPD TYP | IS ‘U=Upd D=Del’ |
| COMMENT ON COLUMN ACP3.A3 RC.A3RC MPRG | IS ‘Maintenance program’ |
| COMMENT ON COLUMN ACP3.A3 RC.A3RC TBL | IS ‘Table name’ |
| COMMENT ON COLUMN ACP3.A3 RC.A3RC TBL K1 | IS ‘Table primary key’ |
| COMMENT ON COLUMN ACP3.A3 RC.A3RC TBL K2 | IS ‘Additional primary key’ |
| COMMENT ON COLUMN ACP3.A3 RC.A3RC TBL K3 | IS ‘Additional primary key’ |
| COMMENT ON COLUMN ACP3.A3 RC.A3RC TBL K4 | IS ‘Additional primary key’ |
| COMMENT ON COLUMN ACP3.A3 RC.A3RC UID | IS ‘Doc. Userid’ |
| COMMENT ON COLUMN ACP3.A3 RC.A3RC TS | IS ‘Doc. Timestamp’ |

CREATE TABLE ACP3.A3 DC
(A3DC DB VARCHAR (10) NOT NULL,
A3DC LIVE CHARACTER (1) NOT NULL,
A3DC PARMS VARCHAR (30) NOT NULL,
A3DC COMM VARCHAIR (60),
PRIMARY KEY (A3DC DB)
) IN USERSPACE1

| | |
|---|---|
| COMMENT ON Table ACP3.A3 DC | IS ‘Database Connection Control Table’ |
| COMMENT ON COLUMN ACP3.A3 DC.A3DC DB | IS ‘Logical database name/alias’ |
| COMMENT ON COLUMN ACP3.A3 DC.A3DC LIVE | IS ‘L=Live D=Down O=Offline’ |
| COMMENT ON COLUMN ACP3.A3 DC.A3DC PARMS | IS ‘Connection parameters’ |
| COMMENT ON COLUMN ACP3.A3 DC.A3DC COMM | IS ‘Comment’ |

What is claimed is:

1. A method of controlling, storing, distributing, and recovering updates among a group of peer databases sharing common data within a processing network consisting of:
1.A. a logically separate control database (but not limited to only a single control database) that contains replica control information and may contain any number of tables necessary to hold the replica and any other control information necessary for the proper function of this invention,
1.B. an optional housekeeping daemon (or agent) process that may periodically test database connectivity, controls replication daemon activity, and removes any completed records,
1.C. a number of replication daemon (or agent) processes that apply the replica information to other peer databases within the processing group,
1.D. a number of designated tables in each peer database to hold replica and any other control information necessary for the proper functioning of this invention.

2. The method of using a sequence number or a unique incremental value within a database record to control the order of updates made within the system.

3. The method of using database trigger code, program code within the database management system, or external code to create said replica control information within the said control database and to validate that the intended update has not be preceded by another update made on a different peer database.

4. The method of recovering the said replica control information contained in the said control database by distributing and gathering the update receipts that are created when the replica is applied to each peer database that have been designated as part of the recovery system.
